(19) United States
(12) Patent Application Publication
(10) Pub. No.: US 2025/0277997 A1
(43) Pub. Date: Sep. 4, 2025

(54) DISPLAY ARTICLES COMPRISING VARIABLE TRANSMITTANCE COMPONENTS AND METHODS OF OPERATING THE SAME

(71) Applicant: CORNING INCORPORATED, CORNING, NY (US)

(72) Inventors: Mingqian He, Horseheads, NY (US); Xiang-Dong Mi, Pittsford, NY (US); Yawei Sun, Elmira, NY (US)

(21) Appl. No.: 18/863,542

(22) PCT Filed: Apr. 28, 2023
(86) PCT No.: PCT/US2023/020308

§ 371 Date: Nov. 6, 2024

Related U.S. Application Data
(60) Provisional application No. 63/406,335, filed on Sep. 14, 2022.
(60) Provisional application No. 63/341,188, filed on May 12, 2022.

(51) Int. Cl. G02F 1/1333; B60K 35/22; G02F 1/1337; G02F 1/163; G02F 1/167; G02F 1/1685

(52) U.S. Cl. CPC G02F 1/133331; B60K 35/22; G02F 1/133742; G02F 1/163; G02F 1/167; G02F 1/1685; B60K 2360/28; G02F 2202/04; G02F 2202/06

(57) ABSTRACT

The present disclosure describes glass articles comprising a glass substrate and a variable transmittance component disposed on the glass substrate. The variable transmittance component comprises an electrically responsive material configured to switch between a first transmission state and a second transmission state in response to a change in voltage applied to the variable transmittance component. The variable transmittance component is electrically adjustable between a first configuration, in which at least a portion of the electrically responsive material is in the first transmission state such that a first average transmittance of a region of the glass article including the portion is less than or equal to 25% and a second configuration, in which the portion of the electrically responsive material is in the second transmission state and the region comprises a second average transmittance that is greater than or equal to 40%. In the first configuration, a deadfronting effect is realized.

### PRIORITY

This application claims the benefit of priority under 35 U.S.C. § 119 of U.S. Provisional Application Ser. No. 63/341,188, filed on May 12, 2022, and 63/406,335, filed on Sep. 14, 2022, the contents of which are relied upon and incorporated herein by reference in their entirety.

### FIELD

The disclosure relates to display articles comprising variable transmittance components for adjusting a transmittance state thereof to provide a deadfronted and/or color-matched appearance and methods of operating the same.

### BACKGROUND

In various applications involving displays, it is desirable to have a display surface or functional surface having a deadfront appearance, where there is a seamless transition between the deadfronted area of an article and a non-deadfronted area. Deadfronting techniques may be used, for example, to hide the edges of a display panel or the like when the article is viewed from a cover surface (e.g., of a plastic or glass display cover material). It is desirable from an aesthetic or design standpoint to have a deadfronted appearance such that, when the display is off, the display and non-display areas present as indistinguishable from one other and the cover surface presents a unified appearance. Applications where a deadfront appearance is desirable include automotive interiors, including in-vehicle displays or touch interfaces, as well as other applications in consumer mobile or home electronics, including mobile devices and home appliances.

Existing deadfronting techniques typically involve the application of films or layers that lower the overall optical transmission of the entire assembly (e.g., including the display panel and cover material). Such a lower optical transmission (especially in the visible spectrum) may aid in concealing certain components from view but have a detrimental effect on display performance by reducing the amount of light emitted by the display that reaches viewers.

Accordingly, an alternative deadfronting approach that provides a uniform or deadfronted appearance without detrimentally impacting display performance is desired.

### SUMMARY

An aspect (1) of the present disclosure pertains to a glass article comprising: a glass substrate comprising a first major surface and a second major surface opposite the first major surface; and a variable transmittance component disposed on the second major surface of the glass substrate, the variable transmittance component comprising an electrically responsive material configured to switch between a first transmission state and a second transmission state in response to a change in voltage applied to the variable transmittance component, wherein: the variable transmittance component is electrically adjustable between a first configuration, in which at least a portion of the electrically responsive material is in the first transmission state such that a first average transmittance of a region of the glass article including the portion is less than or equal to 25% and a second configuration, in which the portion of the electrically responsive material is in the second transmission state and the region comprises a second average transmittance that is greater than or equal to 40%, the first average transmittance and the second average transmittance are measured over a wavelength range of 400 nm to 700 nm, and in both the first configuration and the second configuration, the glass article exhibits a transmission haze that is less than or equal to 5%.

An aspect (2) of the present disclosure pertains to a glass article according to the aspect (1), wherein, in both the first configuration and the second configuration, the glass article exhibits an average reflectance less than or equal to 5% for light from 400 nm to 700 nm that is normally incident on the first major surface.

An aspect (3) of the present disclosure pertains to a glass article according to any of the aspects (1)-(2), wherein: the variable transmittance component defines a boundary between a first region of the glass article and a second region of the glass article, the first region at least partially surrounding the second region, the portion that changes from the first transmission state to the second transmission state when the variable transmittance component is adjusted between the first configuration and the second configuration is disposed in the second region, when the variable transmittance component is in the first configuration, a difference between average transmittances of the first region and the second region is less than or equal to 10%, and when the variable transmittance component is in the second configuration, the difference between the average transmittances is greater than or equal to 40%.

An aspect (4) of the present disclosure pertains to a glass article according to any of the aspects (1)-(3), further comprising a light source disposed adjacent the variable transmittance component, wherein the light source is configured to emit light through the portion that changes from the first transmission state to the second transmission state when the variable transmittance component is adjusted between the first configuration and the second configuration

An aspect (5) of the present disclosure pertains to a glass article according to the aspect (4), wherein the light source comprises a display unit.

An aspect (6) of the present disclosure pertains to a glass article according to any of the aspects (4)-(5), further comprising a control system communicably coupled with the variable transmittance component and the light source, wherein the control system is configured to place the variable transmittance component in the first configuration when the light source is not emitting light such that the glass article has a uniform appearance when viewed from the first major surface.

An aspect (7) of the present disclosure pertains to a glass article according to the aspect (6), wherein the control system is configured to place the variable transmittance component in the second configuration when the light source is emitting light.

An aspect (8) of the present disclosure pertains to a glass article according to the aspect (4), wherein, when the light source is emitting light and the variable transmittance component is in the second configuration, the glass article exhibits a sparkle of 2% or less when viewed from the first major surface.

An aspect (9) of the present disclosure pertains to a glass article according to any of the aspects (1)-(8), wherein: irrespective of whether the variable transmittance component is in the first configuration or the second configuration, a peripheral region of the glass article comprises an average transmittance that is less than or equal to 20% for light from 400 nm to 700 nm, when the variable transmittance component is in the first configuration, the peripheral region comprises a first a* value and a first b* value and the portion that changes from the first transmission state to the second transmission state when the variable transmittance component is adjusted between the first configuration and the second configuration comprises a second a* value and a second b* value, when the glass article is illuminated using a D65 illuminant at an illumination angle of 0°, the first a* value and the second a* value differ from one another by less than or equal to 5.0, and the first b* value and the second b* value differ from one another by less than or equal to 5.0.

An aspect (10) of the present disclosure pertains to a glass article according to the aspect (9), wherein ΔE=√{(a*₁−a*₂)²+(b*₁−b*₂)²}≤3, where a*₁ is the first a* value, a*₂ is the second a* value, b*₁ is the first b* value, and b*₂ is the second b* value.

An aspect (11) of the present disclosure pertains to a glass article according to any of the aspects (1)-(10), wherein the first average transmittance is less than or equal to 10% and the second average transmittance is greater than or equal to 80%.

An aspect (12) of the present disclosure pertains to a glass article according to any of the aspects (1)-(11), wherein the variable transmittance component comprises a first electrode, the electrically responsive material, and a second electrode, wherein the electrically responsive material is disposed between the first electrode and the second electrode and the first electrode is disposed proximate to the glass substrate.

An aspect (13) of the present disclosure pertains to a glass article according to the aspect (12), wherein the electrically responsive material comprises an uncovered portion that is not overlapped by the first and second electrodes such that the uncovered portion is permanently in the second transmission state.

An aspect (14) of the present disclosure pertains to a glass article according to the aspect (12), wherein the electrically responsive material is segmented into a plurality of independently controllable portions.

An aspect (15) of the present disclosure pertains to a glass article according to the aspect (14), wherein the first electrode and the second electrode are segmented into a plurality of electrode portions overlapping the plurality of independently controllable portions of the electrically responsive material.

An aspect (16) of the present disclosure pertains to a glass article according to any of the aspects (12)-(16), wherein the variable transmittance component comprises: a first substrate adjacent the second major surface of the glass substrate; and a second substrate, wherein the first electrode, the electrically responsive material, and the second electrode are disposed between the first substrate and the second substrate.

An aspect (17) of the present disclosure pertains to a glass article according to any of the aspects (11)-(16), wherein the electrically responsive material comprises an electrophoretic layer or an electrochromic layer.

An aspect (18), of the present disclosure pertains to a glass article according to any of the aspects (11)-(16), wherein the electrically responsive material comprises a liquid crystal layer.

An aspect (19) of the present disclosure pertains to a glass article according to the aspect (18), wherein the liquid crystal layer comprises a mixture of nematic liquid crystal, a dichroic dye, and a chiral dopant.

An aspect (20) of the present disclosure pertains to a glass article according to the aspect (19), wherein: the dichroic dye comprises greater than or equal to 1 wt % and less than or equal to 5 wt % of the mixture, and a cell gap of the nematic liquid crystal is greater than or equal to 3 μm and less than or equal to 20 μm.

An aspect (21) of the present disclosure pertains to an apparatus comprising a glass substrate comprising a first major surface and a second major surface opposite the first major surface; a variable transmittance component disposed on the second major surface of the glass substrate, the variable transmittance component comprising an electrically responsive material configured to switch between a first transmission state and a second transmission state in response to a change in voltage applied to the variable transmittance component; and a light source disposed on a surface of the variable transmittance component, the light source comprising a light transmission area, wherein: the electrically responsive material covers the light transmission area of the light source such that light emitted by the light source propagates through the electrically responsive material prior to reaching the glass substrate, the variable transmittance component is electrically adjustable between a first configuration, in which at least a portion of the electrically responsive material is in the first transmission state such that a first average transmittance of a region of the glass article including the portion is less than or equal to 20% and a second configuration, in which the portion of the electrically responsive material is in the second transmission state and the region comprises a second average transmittance that is greater than or equal to 60%, the first average transmittance and the second average transmittance are measured over a wavelength range of 400 nm to 700 nm, and in both the first configuration and the second configuration, the glass article exhibits at least one of a transmission haze that is less than or equal to 5% or an average an average reflectance less than or equal to 5% for light from 400 nm to 700 nm that is normally incident on the first major surface.

An aspect (22) of the present disclosure pertains to an apparatus according to the aspect (21), wherein the variable transmittance component defines a boundary between (a) a first region of the glass article overlapping the light transmission area in a direction perpendicular to the surface of the variable transmittance component and (b) a second region of the glass article.

An aspect (23) of the present disclosure pertains to an apparatus according to any of the aspects (21)-(22), wherein the light source comprises a display unit.

An aspect (24) of the present disclosure pertains to an apparatus according to any of the aspects (21)-(23), further comprising a control system communicably coupled with the variable transmittance component and the light source, wherein the control system is configured to place the variable transmittance component in the first configuration when the light source is not emitting light such that the glass article has a uniform appearance when viewed from the first major surface.

An aspect (25) of the present disclosure pertains to an apparatus according to the aspect (24), wherein the control system is configured to place the variable transmittance component in the second configuration when the light source is emitting light.

An aspect (26) of the present disclosure pertains to an apparatus according to any of the aspects (21)-(25), wherein: irrespective of whether the variable transmittance component is in the first configuration or the second configuration, a peripheral region of the glass article comprises an average transmittance that is less than or equal to 20% for light from 400 nm to 700 nm, when the variable transmittance component is in the first configuration, the peripheral region comprises a first a* value and a first b* value and the region containing the portion that changes from the first transmission state to the second transmission state when the variable transmittance component is adjusted between the first configuration and the second configuration comprises a second a* value and a second b* value, when the glass article is illuminated using a D65 illuminant at an illumination angle of 0°, the first a* value and the second a* value differ from one another by less than or equal to 5.0, and the first b* value and the second b* value differ from one another by less than or equal to 5.0.

An aspect (27) of the present disclosure pertains to an apparatus according to the aspect (26), wherein ΔE=√{(a*₁−a*₂)²+(b*₁−b*₂)²}≤3, where a*₁ is the first a* value, a*₂ is the second a* value, b*₁ is the first b* value, and b*₂ is the second b* value.

An aspect (28) of the present disclosure pertains to an apparatus according to any of the aspects (21)-(27), wherein, when the light source is emitting light and the variable transmittance component is in the second configuration, the glass article exhibits a sparkle of 2% or less when viewed from the first major surface.

An aspect (29) of the present disclosure pertains to an apparatus according to any of the aspects (21)-(28), wherein the first average transmittance is less than or equal to 10%.

An aspect (30) of the present disclosure pertains to an apparatus according to any one of the aspects (21)-(29), wherein the second average transmittance is greater than or equal to 80%.

An aspect (31) of the present disclosure pertains to an apparatus according to any one of the aspects (21)-(30), wherein the variable transmittance component comprises a first electrode, the electrically responsive material, and a second electrode, wherein the electrically responsive material is disposed between the first electrode and the second electrode and the first electrode is disposed proximate to the glass substrate.

An aspect (32) of the present disclosure pertains to an apparatus according to the aspect (31), wherein the electrically responsive material comprises an uncovered portion that is not overlapped by the first and second electrodes such that the uncovered portion is permanently in the second transmission state.

An aspect (33) of the present disclosure pertains to an apparatus according to the aspect (31), wherein the electrically responsive material is segmented into a plurality of independently controllable portions.

An aspect (34) of the present disclosure pertains to an apparatus according to the aspect (33), wherein the first electrode and the second electrode are segmented into a plurality of electrode portions overlapping the plurality of independently controllable portions of the electrically responsive material.

An aspect (35) of the present disclosure pertains to an apparatus according to any of the aspects (31)-(34), wherein the variable transmittance component comprises: a first substrate adjacent the second major surface of the glass substrate; and a second substrate, wherein the first electrode, the electrically responsive material, and the second electrode are disposed between the first substrate and the second substrate.

An aspect (36) of the present disclosure pertains to an apparatus according to any of the aspects (31)-(35), wherein the electrically responsive material comprises an electrophoretic layer or an electrochromic layer.

An aspect (37) of the present disclosure pertains to an apparatus according to any of the aspects (31)-(35), wherein the electrically responsive material comprises a liquid crystal layer.

An aspect (38) of the present disclosure pertains to an apparatus according to the aspect (37), wherein the liquid crystal layer comprises a mixture of nematic liquid crystal, a dichroic dye, and a chiral dopant.

An aspect (39) of the present disclosure pertains to an apparatus according to the aspect (38), wherein: the dichroic dye comprises greater than or equal to 1 wt % and less than or equal to 5 wt % of the mixture, and a cell gap of the nematic liquid crystal is greater than or equal to 3 μm and less than or equal to 20 μm.

An aspect (40) of the present disclosure pertains to a method comprising: operating a variable transmittance component of a glass article in a first configuration such that the glass article exhibits a substantially uniform transmittance over an entirety of the glass article, wherein the glass article comprises a glass substrate and the variable transmittance component disposed on a major surface of the glass substrate, wherein the variable transmittance component comprises an electrically responsive material configured to switch between a first transmission state and a second transmission state in response to a change in voltage to the variable transmittance component, wherein, when the variable transmittance component is operated in the first configuration, the electrically responsive material is in the first transmission state such that the glass article exhibits an average transmittance of less than or equal to 25% throughout the visible spectrum and the glass article has a uniform appearance; emitting the light from the light source to cause the light to propagate through the variable transmittance component and the glass substrate; and while the light source is emitting light, operating the variable transmittance component in a second configuration in which at least a portion of the electrically responsive material is in the second transmission state such that an average transmittance of a region of the glass article containing the portion is greater than or equal to 40%, while the region of the glass article exhibits at least one of a transmission haze that is less than or equal to 5% or an average an average reflectance less than or equal to 5% for light from 400 nm to 700 nm that is normally incident on the first major surface.

An aspect (41) of the present disclosure pertains to a method according to the aspect (40), wherein the variable transmittance component is changed from the first configuration to the second configuration automatically in response to the light source emitting the light.

An aspect (42) of the present disclosure pertains to a method according to any of the aspects (40)-(41), wherein the operating the variable transmittance component in the first configuration comprises one of applying a voltage to electrodes of the variable transmittance component and removing application of the voltage to the electrodes.

An aspect (43) of the present disclosure pertains to a method according to the aspect (42), wherein the operating the variable transmittance component in the second configuration comprises the other of applying a voltage to electrodes of the variable transmittance component and removing application of the voltage to the electrodes.

An aspect (44) of the present disclosure pertains to a method according to any of the aspects (40)-(43), wherein the region of the glass article corresponds to an area over which the light source emits light.

An aspect (45) of the present disclosure pertains to a method according to any of the aspects (40)-(44), wherein the light source comprises a display unit and the region of the glass article corresponds to a size of an image emitted by the display unit.

An aspect (46) of the present disclosure pertains to a method according to any of the aspects (40)-(45), further comprising changing a transmission state of the electrically responsive material locally in portions of the region such that the portions exhibit average transmittances that differ from one another.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a vehicle interior with vehicle interior systems having displays, according to one or more embodiments of the present disclosure;

FIG. 2 schematically depicts a view of a display of a vehicle interior system through the line 2-2 depicted in FIG. 1, according to one or more embodiments of the present disclosure;

FIG. 3 schematically depicts a view of a variable transmittance component of the display depicted in FIGS. 1-2, according to one or more embodiments of the present disclosure;

FIG. 4 schematically depicts a view of a variable transmittance component of the display depicted in FIGS. 1-2, according to one or more embodiments of the present disclosure;

FIG. 5 depicts a flow diagram of a method of operating a display comprising a light source and a variable transmittance component, according to one or more embodiments of the present disclosure; and

FIG. 6 schematically depicts a view of a glass substrate, according to one or more embodiments of the present disclosure.

### DETAILED DESCRIPTION

Referring generally to the figures, described herein are glass articles providing deadfronting for various applications via incorporation of a variable transmission component. The variable transmission component comprises an electrically responsive material configured to switch between a first transmission state and a second transmission state in response to a change in voltage applied to the variable transmittance component. The variable transmittance component is electrically adjustable between a first configuration, in which the electrically responsive material is in the first transmission state and the glass article comprises a first average transmittance for light in the visible spectrum, and a second configuration, in which the electrically responsive material is in the second transmission state and the glass article comprises a second average transmittance computed for light in the visible spectrum. The first average transmittance is greater than the second average transmittance by at least 40%. In embodiments, for example, the first average transmittance is less than 25% (e.g., less than or equal to 24%, less than or equal to 23%, less than or equal to 22%, less than or equal to 21%, less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%), while the second average transmittance is greater than 40% (e.g., greater than or equal to 45%, greater than or equal to 50%, greater than or equal to 55%, greater than or equal to 60% greater than or equal to 65%, greater than or equal to 70%, greater than or equal to 75%, greater than or equal to 80%, greater than or equal to 90%). The variable transmittance component may also be designed to provide a uniform appearance when the glass article is viewed from a surface of the glass substrate (e.g., by being coextensive with the glass substrate or via a color-matched appearance with additional components of the glass article, as described herein). As such, when the variable transmittance component is in the first configuration, items (e.g., display components, electrical connections, housings, fasteners) disposed behind the variable transmittance component along an optical path may be concealed from view and the glass article may have a uniform appearance. However, when the variable transmittance component is in the second configuration, the glass article may exhibit a relatively high optical transmission to avoid detrimentally effecting a display image to the same extent as existing deadfronting techniques. The variable transmittance components described herein therefore provide effective deadfronting without significantly inhibiting the performance of the display.

In embodiments, the variable transmittance component is constructed to provide favorable performance attributes for display applications. In embodiments, for example, the electrically responsive material is selected to provide relatively low transmission haze of less than or equal to 5% (e.g., less than or equal to 4.0%, less than or equal to 3.0%, less than or equal to 2.9%, less than or equal to 2.8%, less than or equal to 2.7%, less than or equal to 2.6%, less than or equal to 2.5%, less than or equal to 2.4%, less than or equal to 2.3%, less than or equal to 2.2%, less than or equal to 2.1%, less than or equal to 2.0%) when in both transmission states to aid in maintaining contrast of the display image. In embodiments, the electrically responsive material is also selected such that the variable transmittance component exhibits a relatively low average reflectance for light in the visible spectrum (e.g., less than or equal to 5.0%, less than or equal to 4.0%, less than or equal to 3.0%, less than or equal to 2.0%, less than or equal to 1.0%) in both transmission states to prevent glare and other detrimental appearance attributes. The entire glass article incorporating the variable transmittance component may have an average reflectance of less than 2% for light from 400 nm to 700 nm, provided that an anti-reflection layer is added to reduce reflection at the glass substrate. In embodiments, the electrically responsive material may comprise a liquid crystal layer comprising nematic liquid crystal, an electrochromic layer, or an electrophoretic layer. Components that tend to scatter (e.g., suspended particles, polymer-dispersed liquid crystal material) or reflect (e.g., mirror-based components separate from the electrically responsive material, micro-electrical mechanical system-based components) light are beneficially avoided to facilitate favorable display performance.

In embodiments, the variable transmittance component structurally defines a boundary between different regions of the glass article that may exhibit different average transmittances for light in the visible spectrum, depending on the configuration of the electrically responsive material. For example, in embodiments, a peripheral edge of the electrically responsive material (or an edge of an electrode conductively coupled thereto) coincides with a boundary of an image region of the glass article, through which light generated by an accompanying light source is transmitted for viewing. In such embodiments, operating the variable transmittance component in the first configuration may cause the image region to be color-matched with a peripheral region of the glass article at least partially surrounding the image region (e.g., such a peripheral region may comprise an opaque layer as described herein), thereby providing the glass article a uniform appearance and concealing components from view. In embodiments, the electrically responsive material is segmented into portions that are adjustable between transmission states independently of one another. For example, in embodiments, the electrically responsive material comprises a first portion disposed in the image region and a second portion disposed in the peripheral region, and the variable transmittance component may comprise an electrode structure that facilitates the first portion and the second portion being operated in different transmission states at the same time. When the light source is emitting light, for example, the first portion may be operated in the second transmission state such that a substantial portion of the emitted light is transmitted through the glass article, while the second portion is operated in the first transmission state, to maintain concealment of components at the periphery of the glass article. When the light source is not emitting light, both the first and second portions may be operated in the first transmission state such that the glass article exhibits a uniform deadfronted appearance. Providing such structural boundaries of adjustable optical transmission contrast beneficially provides flexibility for multiple configurations and appearances.

In aspects, the variable transmittance components of the present disclosure may also be controlled responsive to a variety of inputs to provide operational flexibility. In embodiments, for example, the electrically responsive material may be adjusted from the first transmission state to the second transmission state in response to light emission by the accompanying light source. This way, the glass article is only transmissive when light from the light source is potentially being viewed. In embodiments, the electrically responsive material may be switched between transmission states responsive to inputs by a user (e.g., via a touch panel associated with the light source or other component, via a proximity sensor, via a sensor tracking the eyes of one or more viewers), such that the user may alter the appearance of the glass article. Such flexibility is not realized by current deadfronting solutions.

As used herein, the terms “optical transmission,” “percent transmission,” and “transmittance” are used interchangeably and refer to a percentage of light transmitted through an article over a wavelength range of interest. An “average transmittance” for light in a particular wavelength range is determined by averaging a measured optical transmission at all of the whole number wavelengths within that wavelength range.

As used herein, the terms “optical reflectance,” “percent reflectance,” and “reflectance” are used interchangeably and refer to a percentage of light reflected from an article over a wavelength range of interest. When a reflectance of a particular surface is mentioned, the referred-to value only applies to a single surface of the glass article (e.g., of a surface of a variable transmittance component). An “average optical reflectance” for light in a particular wavelength range is determined by averaging a measured optical reflectance at all of the whole number wavelengths within that wavelength range.

As used, herein, the term “haze” or “transmission haze” refers to the percentage of transmitted light scattered outside an angular cone of about +2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well.

As used herein, the term “sparkle” refers to a measured value in terms of pixel power deviation referenced (PPDr). The terms “pixel power deviation referenced” and “PPDr” refer to the quantitative measurement for display sparkle. Unless otherwise specified, PPDr is measured using a display arrangement that includes an edge-lit liquid crystal display screen (twisted nematic liquid crystal display) having a native sub-pixel pitch of 60 μm by 180 μm and a sub-pixel opening window size of 44 μm by 142 μm. The front surface of the liquid crystal display screen had a glossy, anti-reflection type linear polarizer film. To determine PPDr of a display system or an anti-glare surface that forms a portion of a display system, a screen is placed in the focal region of an “eye-simulator” camera, which approximates the parameters of the eye of a human observer. As such, the camera system includes an aperture (or “pupil aperture”) that is inserted into the optical path to adjust the collection angle of light, and thus approximate the aperture of the pupil of the human eye. In the PPDr measurements described herein, the iris diaphragm subtends an angle of 18 milliradians. A first image of the bare display is taken and used as a reference for the image taken with the test sample containing the anti-glare surface. A second image is taken with the substrate positioned between the display and the camera. The boundaries between adjacent pixels are calculated by summing the lines then rows in the image and determining the minima. Total power within each pixel is then integrated and normalized by dividing by the pixel powers from the reference image. The standard deviation of the distribution of pixel powers is then calculated to give the PPDr value. Further information regarding these properties and how these measurements are made can be found in (1) C. Li and T. Ishikawa, Effective Surface Treatment on the Cover Glass for Auto-Interior Applications, SID Symposium Digest of Technical Papers, Volume 1, Issue 36.4, pp. 467 (2016); (2) J. Gollier, G. A. Piech, S. D. Hart, J. A. West, H. Hovagimian, E. M. Kosik Williams, A. Stillwell and J. Ferwerda, Display Sparkle Measurement and Human Response, SID Symposium Digest of Technical Papers, Volume 44, Issue 1 (2013); and (3) J. Ferwerda, A. Stillwell, H. Hovagimian and E. M. Kosik Williams, Perception of sparkle in an anti-reflection and/or an anti-glare display screen, Journal of the SID, Volume 22, Issue 2 (2014), the contents of which are incorporated herein by reference.

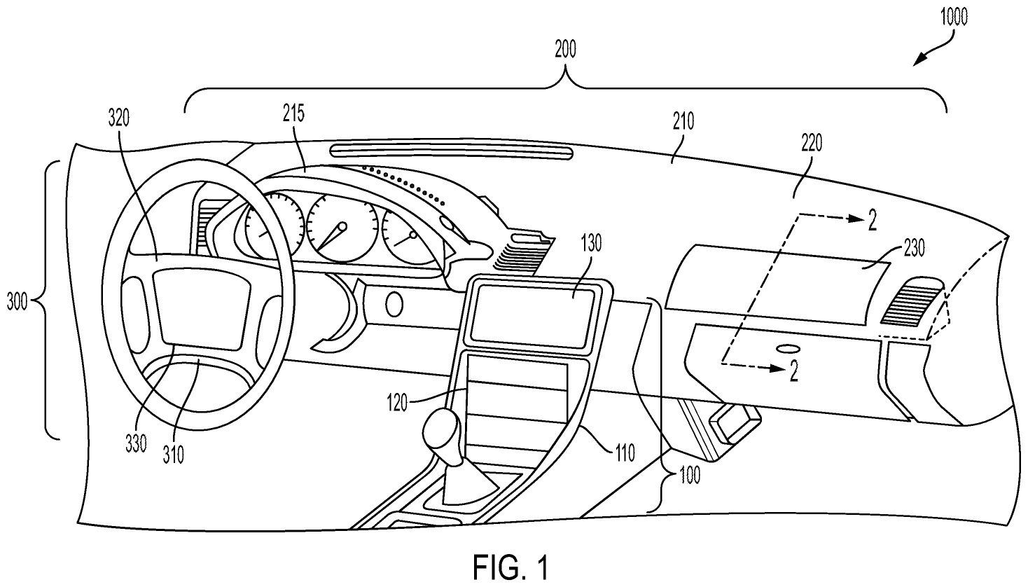

FIG. 1 shows a vehicle interior 1000 that includes three different vehicle interior systems 100, 200, 300, according to an exemplary embodiment. Vehicle interior system 100 includes a center console base 110 with a curved surface 120 including a display 130. Vehicle interior system 200 includes a dashboard base 210 with a curved surface 220 including a display 230. The dashboard base 210 typically includes an instrument panel 215 which may also include a display. Vehicle interior system 300 includes a dashboard steering wheelbase 310 with a curved surface 320 and a display 330. In one or more embodiments, the vehicle interior system may include a base that is an arm rest, a pillar, a seat back, a floorboard, a headrest, a door panel, or any portion of the interior of a vehicle that includes a curved surface. In embodiments, the displays 130, 230, 330 are flat and comprise cover glass with planar major surfaces. In embodiments, one or more of the displays 130, 230, 330 are curved, and the curved display may include curved cover glass that may be hot-formed or cold-formed to possess such curvature. For example, such embodiments may incorporate the variable transmittance components described herein disposed on cold-formed glass substrates (e.g., either prior to or after the glass is cold-forming). Such cold-forming may involve any of the techniques described in U.S. Pre-Grant Publication No. 2019/0329531 A1, entitled “Laminating thin strengthened glass to curved molded plastic surface for decorative and display cover application,” U.S. Pre-Grant Publication No. 2019/0315648 A1, entitled “Cold-formed glass article and assembly process thereof,” U.S. Pre-Grant Publication No. 2019/0012033 A1, entitled “Vehicle interior systems having a curved cover glass and a display or touch panel and methods for forming the same,” and U.S. patent application Ser. No. 17/214,124, entitled “Curved glass constructions and methods for forming same,” which are hereby incorporated by reference in their entireties.

The embodiments of the glass articles described herein can be used in any or all of vehicle interior systems 100, 200 and 300. While FIG. 1 shows an automobile interior, the various embodiments of the vehicle interior system may be incorporated into any type of vehicle such as trains, automobiles (e.g., cars, trucks, buses and the like), seacraft (boats, ships, submarines, and the like), and aircraft (e.g., drones, airplanes, jets, helicopters and the like), including both human-piloted vehicles, semi-autonomous vehicles and fully autonomous vehicles. Further, while the description herein relates primarily to the use of the glass articles in vehicle displays, it should be understood that various embodiments discussed herein may be used in any type of display application. The present disclosure is also not limited to display applications, but could be used in any deadfronting application.

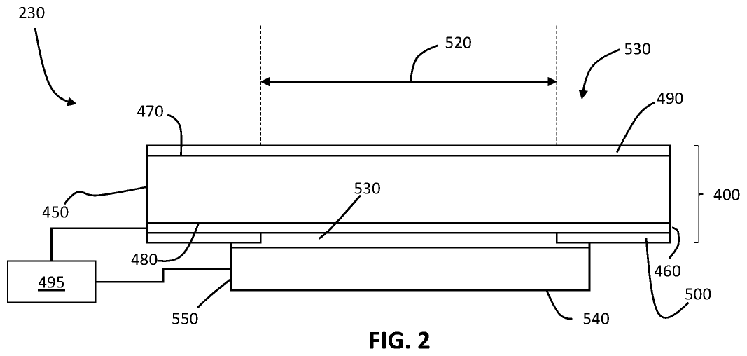

FIG. 2 schematically depicts a cross-sectional view of the display 230 through the line 2-2 of FIG. 1, according to an example embodiment where the display 230 is flat. While FIG. 2 depicts an example of the display 230, it should be understood that the displays 130, 330 described herein with respect to FIG. 1 may have similar cross-sectional structures and incorporate the variable transmittance components described herein in a similar manner. While the display 230 is flat in the embodiment depicted in FIG. 2, embodiments are also envisioned where the display 230 is curved and the glass article 400 comprises one or more curved surfaces (e.g., as a result of being cold-formed or hot-formed to have a suitable curved shape).

As shown in FIG. 2, the glass article 400 comprises at least a glass substrate 450, a variable transmittance component 460, and optionally includes an opaque layer 500. The glass substrate 450 has a first major surface 470 facing a viewer and a second major surface 480 upon which the variable transmittance component 460 is disposed. The variable transmittance component 460 may be attached to the second major surface 480 using a suitable optically clear adhesive. As used herein, the term “dispose” includes coating, depositing and/or forming a material onto a surface using any known method in the art. The disposed material may constitute a layer, as defined herein. As used herein, the phrase “disposed on” includes the instance of forming a material onto a surface such that the material is in direct contact with the surface and also includes the instance where the material is formed on a surface, with one or more intervening material(s) is between the disposed material and the surface. The intervening material(s) may constitute a layer, as defined herein. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

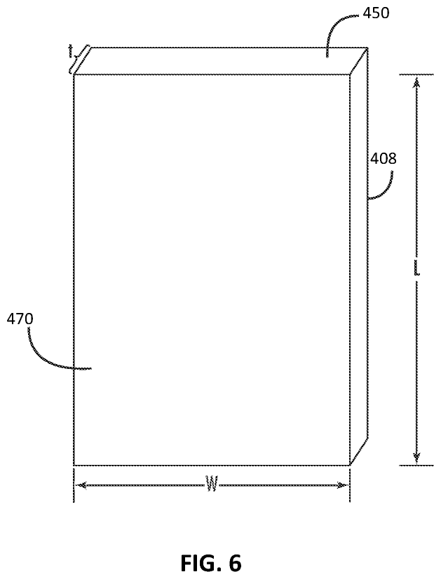

In embodiments, the glass substrate 450 is a glass substrate that is optionally chemically strengthened and comprises a thickness of from 0.05 to 2.0 mm. Details of such glass substrates will be described herein with respect to FIG. 6. Although embodiments are preferred where the substrate is the glass substrate 450, alternative embodiments may include a substrate constructed of an alternative material, such as a transparent plastic, such as PMMA, polycarbonate and the like. As will also be discussed more fully below, in embodiments, when included, the opaque layer 500 is printed onto the second major surface 480 of the glass substrate 450. In embodiments, the opaque layer 500 is printed onto the variable transmittance component 460.

In embodiments, the glass article 400 comprises a functional surface layer 490. The functional surface layer 490 can be configured to provide one or more of a variety of functions. For example, the functional surface layer 490 may be optical coating configured to provide easy-to-clean performance, anti-glare properties, and/or antireflection properties. Such optical coatings can be created using single layers or multiple layers. In the case of anti-reflection functional surface layers, such layers may be formed using multiple layers having alternating high refractive index and low refractive index. Non-limiting examples of low refractive index films include SiO₂, MgF₂, and Al₂O₃, and non-limiting examples of high refractive index films include Nb₂O₅, TiO₂, ZrO₂, HfO₂, and Y₂O₃. In embodiments, the total thickness of such an optical coating (which may be disposed over an anti-glare surface or a smooth substrate surface) is from 5 nm to 750 nm. Additionally, in embodiments, the functional surface layer 490 that provides easy-to-clean performance also provides enhanced feel for touch screens and/or coating/treatments to reduce fingerprints. In some embodiments, functional surface layer 490 is integral to the first surface of the substrate. For example, such functional surface layers can include an etched surface in the first surface of the glass substrate 450 providing an anti-glare surface (or haze of from, e.g., 2% to 10%). In embodiments, both the first major surface 470 and the second major surface 480 of the glass article 400 comprise any of the functional layers described herein.

In embodiments, the opaque layer 500, when included, is constructed of a suitable ink (e.g., thermally curable ink, photocurable ink) and comprises a relatively high optical density, e.g., an optical density of greater than 3, greater than or equal to 4, greater than or equal to 5, in order to block light transmittance. In embodiments, the opaque layer 500 is used to block light from transmitting trough certain regions of the glass article 400. In embodiments, the opaque layer 500 obscures functional or non-decorative elements provided for the operation of the glass article 400. In embodiments, the opaque layer 500 is provided to outline backlit icons and/or other graphics (not depicted) so as to increase the contrast at the edges of such icons and/or graphics. The opaque layer 500 can be any color; in particular embodiments, though, the opaque layer 500 is black or gray. In embodiments, the opaque layer 500 is applied via inkjet printing, screen printing, coating, or other suitable technique over the variable transmittance component 460 and/or over the second major surface 480 of the glass substrate 450. Generally, the thickness of the opaque layer 500 is less than or equal to 25 μm (e.g., greater than or equal to 1.0 μm and less than or equal to 25.0 μm, greater than or equal to 5.0 μm and less than or equal to 25.0 μm, greater than or equal to 5.0 μm and less than or equal to 20.0 μm, greater than or equal to 5.0 μm and less than or equal to 10.0 μm).

In embodiments, the opaque layer 500, when included, may be directly deposited onto the second major surface 480 of the glass substrate 450 or variable transmittance component 460 using a suitable inkjet process. In embodiments, prior to deposition of the opaque layer 500, the second major surface 480 or variable transmittance component 460 may be primed using a suitable primer (e.g., an acryloxy silane primer) to facilitate adhesion of the opaque layer 500 to the glass substrate 450 or variable transmittance component 460. Any suitable treatment to the second major surface 480 may be used to facilitate adhesion of the opaque layer 500 to the glass substrate 450. As described herein, in embodiments, the glass article 450 does not include the opaque layer 500. For example, the variable transmittance component 460 may be configured to define a boundary of optical transmission contrast so as to conceal components from view and provide a desired appearance, thereby eliminating the need for the opaque layer 500.

In embodiments, as shown in FIG. 2, the glass article 400 is placed over or in front of a light source 540. The light source 540 is generally configured to emit light that is transmitted through the glass substrate 450 for viewing from the first major surface 470. The light emitted by the light source 540 may be monochromatic or cover any suitable spectral range to generate a suitable image. In one or more embodiments, the light source 540 comprises a display, such as a touch-enabled displays which include a display and touch panel. Exemplary displays include LED display, a DLP MEMS chip, LCDs, OLEDs, transmissive displays, and the like. In embodiments, the light source 540 comprises another suitable light emission device (e.g, a light-emitting diode or light-emitting diode array, a laser, or other light source).

In embodiments, the high optical density of the opaque layer 500, when included, causes the areas of the glass article 400 incorporating the opaque layer 500 to have relatively low optical transmission (e.g., an average transmittance of less than or equal to 1.0%, less than or equal to 0.5%, or less than or equal to 0.1% in the visible spectrum). Accordingly, the boundaries of the opaque layer 500 may define an image region 520, where the glass article 400 can exhibit a relatively high optical transmission to facilitate visibility of the light generated by the light source 540 when the glass article 450 is viewed from the first major surface 470, and a peripheral region 530, where the glass article 400 generally exhibits a lower optical transmission than in the image region 520 to facilitate concealment of various components. In embodiments, the variable transmittance component 460 (e.g., without the opaque layer 500) defines the boundaries between the peripheral region 530 and the image region 520 by incorporating independently controllable portions that can have different transmittances at the same time, as described herein. In the depicted embodiment, the opaque layer 500 covers the edges 550 of the light source 540 to hide the edges 550 from view through the first major surface 470. The opaque layer 500 may also be used to obscure various other components from view (e.g., electrical connections, mechanical housings, and the like). The opaque layer 500 generally facilitates a desired portion of the light source 540 being viewable by users viewing the first major surface 470.

In the depicted embodiment, the image region 520 is circumferentially surrounded by the peripheral region 530. For example, in embodiments, the peripheral region 530 forms a border of the image region 520 and completely surrounds the image region 520. The border may comprise a uniform width around an entirety of the image region 520. Alternative embodiments, where the peripheral region 530 does not completely surround the image region 520, are also contemplated and within the scope of the present disclosure. For example, in embodiments, the peripheral region 530 may be disposed adjacent to the image region 520 and only extend along a single side of the image region 520. The present disclosure is not limited to applications where the image region 520 of relatively high optical transmission is centrally disposed in the glass article 400.

Referring still to FIG. 2, in embodiments, the variable transmittance component 460 is configured to alter an optical transmission of at least the image region 520 depending on the configuration in which the variable transmittance component 460 is operated. For example, in embodiments, the vehicle interior system 200 (see FIG. 1) comprises a control system 495 communicably coupled to the variable transmittance component 460. The control system 495 may control operation of the variable transmittance component 460 to alter a configuration thereof and change the optical transmission distribution of the glass article 400. In embodiments, for example, the control system 495 is communicably coupled to the light source 540 (e.g., to control operation thereof) and may operate the variable transmittance component 460 in a first configuration, where an average optical transmission for light in the visible spectrum of the glass article 400 in the image region 520 is relatively low (e.g., less than or equal to 20%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, less than or equal to 1%) when the light source 540 is not emitting light. The control system 495 may be configured to alter the configuration of the variable transmission component 460 to a second configuration, in which the average optical transmission of the glass article 400 within the image region 520 is relatively high (e.g., greater than or equal to 40%, greater than or equal to 45%, greater than or equal to 50%, greater than or equal to 55%, greater than or equal to 60%, greater than or equal to 65%, greater than or equal to 70%, greater than or equal to 75%, greater than or equal to 80%) when the light source 540 is emitting light to facilitate viewing. Depending on the configuration in which the variable transmittance component 460 is operated, the optical transmission in at least the image region 520 is changed to facilitate viewing and concealment of the light source 540. Control of the configuration of the variable transmittance component 460 may be based on a variety of inputs (e.g., user inputs via touch or other suitable input mechanisms, light sensors, proximity sensors, location sensors).

Various structures and configurations of the variable transmittance component 460 are contemplated and within the scope of the present disclosure. For example, in embodiments, the variable transmittance component 460 is co-extensive with the glass substrate 450 (e.g., such that variable transmittance component 460 covers an entirety of the second major surface 480). In embodiments, the variable transmittance component 460 may only be disposed in the image region 520 of the glass article 400 (e.g., edges of the variable transmittance component 460 may coincide with (or partially define) a boundary between the image region 520 and the peripheral region 530). For example, the peripheral edge of the variable transmittance component 460 may coincide with the opaque layer 500 (e.g., the opaque layer 500 may contact the peripheral edge of the variable transmittance component to define the peripheral region 530). In embodiments, the variable transmittance component 460 comprises a plurality of independently controllable portions (e.g., the control system 495 may be communicably coupled to each portion). Such independently controllable portions may include a first portion completely disposed in the image region 520 and a second portion completely disposed in the peripheral region 530. Operating such a first and second portion in the same or different optical transmission configurations may alter a spatial distribution of the optical transmission of the glass article 400, depending on the operational state of the light source 540. In embodiments, portions of the variable transmittance component 460 overlapping the peripheral region 530 are always operated in the first transmission state described herein, such that the optical transmission of the peripheral region 530 is always relatively low, so as to conceal components at the periphery of the glass article 400 from view.

In embodiments, the variable transmittance component 460 is configured such that the glass article 400 exhibits a uniform appearance when viewed from the first major surface 470 and the light source 540 is not emitting light. In embodiments, for example, when the variable transmittance component 460 is in the first configuration described herein, the optical transmission of the glass article 400 may be low enough to hide the components of the light source 540 from view. That is, the variable transmittance component 460 may prevent the light source 540 from being visible to viewers when the light source 540 is not emitting light, thereby providing the glass article 400 a favorable appearance.

In embodiments, the variable transmittance component 460 is configured such that the glass article 400 possesses a uniform appearance when viewed from the first major surface 470. For example, in embodiments, the variable transmittance component 460 may cover an entirety of the second major surface 480 and be placed in the first configuration described herein when the light source 540 is not emitting light such that an entirety of the glass article 400 possesses the same appearance (determined by the optical properties of the variable transmittance component 460 in the first configuration). In embodiments, irrespective of whether the opaque layer 500 is included, the image region 520 and the peripheral region 530 may be color-matched when viewed from the first major surface 470 with the variable transmittance component 460 in the first configuration. As described herein, the “color-matched” means that the peripheral region 530 and image region 520 comprise a* and b* values according to the CIELAB color coordinate system that differ from one another by less than or equal to 5.0 (e.g., less than or equal to 4.0, less than or equal to 3.0, or less than or equal to 2.0) when first major surface 470 is illuminated by a D65 illuminant and viewed at a 0° viewing angle.

In embodiments, when the image region 520 and the peripheral region 530 are color-matched (e.g., when the light source 540 is not emitting light and the variable transmittance component 460 is in the first configuration described herein), the glass article 400, when viewed from the first major surface 470, exhibit a color variation ΔE, defined as:

$$ΔE = √ \{ {( {a}_{1}^{*} - {a}_{2}^{*} )}^{2} + {( {b}_{1}^{*} - {b}_{2}^{*} )}^{2} \} \qquad ( 2 )$$

where a*₁ is the a* value of the image region 520, b*₁, is the b* value of the image region 520, a*₂ is the a* value of the peripheral region 530, and b*₂ is the b* value of the peripheral region 530. In embodiments, ΔE is less than or equal to 4.0 (e.g., less than or equal to 3.0, less than or equal to 3.5, less than or equal to 3.0. less than or equal to 2.5, less than or equal to 2.0) when the glass article 400 is illuminated with a D65 illuminant with a 0° illumination angle with the variable transmittance component in the first configuration described herein.

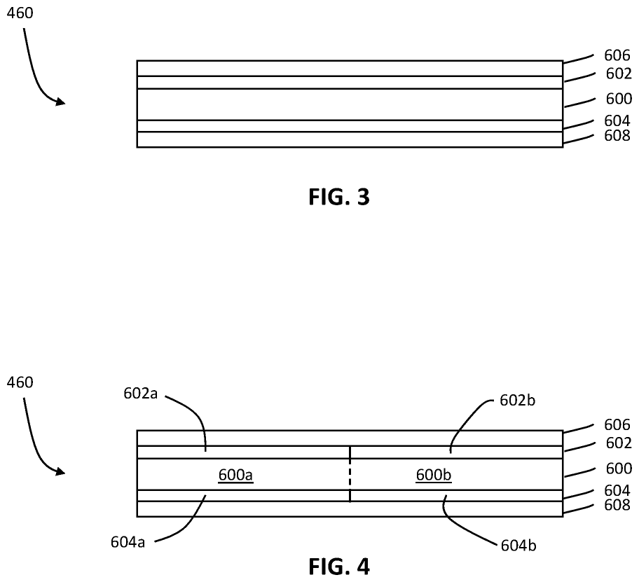

FIG. 3 schematically depicts a view of the variable transmittance component 460, according to an example embodiment. The variable transmittance component 460 comprises an electrically responsive material 600, a first electrode 602, and a second electrode 604. In embodiments, at least one of the first electrode 602 and the second electrode 604 is communicably coupled (e.g., conductively coupled) to the control system 495 (see FIG. 2) to facilitate controlling an optical transmission state of the electrically responsive material 600. The electrically responsive material 600 is configured to change transmission states in response to a change in voltage (or electric field) applied thereto via the first electrode 602 and the second electrode 604. The electrically responsive material 600 may comprise any suitable material capable of reversibly altering the overall optical transmission of the variable transmittance component 460 in the visible spectrum without significantly degrading the optical performance (e.g., in terms of reflectance and/or optical transmission when the electrically responsive material 600 is in a state of relatively high optical transmission) of the glass article 400 so as to impede operation of the light source 540 (see FIG. 2).

In embodiments, the electrically responsive material 600 comprises an electrophoretic material. The electrophoretic material may comprise a dielectric solvent and a dispersion of charged pigment particles. A voltage difference between the first electrode 602 and the second electrode 604 may cause different ones of the charged pigment particles to be attracted to the first electrode 602 and/or the second electrode 604 to thereby change the optical transmission state of the variable transmittance component 460. At least one of the first electrode 602 and the second electrode 604 may be patterned in a suitable arrangement to obtain the desired optical transmission performance attributes. Such patterned electrode may vary a distribution of the charged pigment particles (such that some areas have low concentrations of the pigments particles, while other areas of high concentration of the pigment particles) to effectively increase the average transmittance of the variable transmittance component 460. It is preferred that the pigment particles have similar refractive index to reduce haze.

In embodiments, the electrically responsive material 600 comprises an electrochromic material. In such embodiments, the electrically responsive material 600 comprises an electrochromic layer, an electrolyte, and an ion-storage layer. The electrochromic layer comprises a suitable inorganic or organic (e.g., an electrochromic polymer) material. In embodiments, the electrochromic layer comprises a suitable oxide (e.g., WO₃, NiO, WMoO₃). The electrolyte may comprise a suitable material configured to transport protons supplied by the ion-storage layer. Any suitable existing electrochromic cell structure may be used. Generally, supply of electrons from the first and second electrodes 602 and 604 and ions from the ion storage layer may facilitate a reduction reaction that in turn facilitates electron exchange via photon absorption, causing changes in optical transmittance depending on the voltage applied across the first and second electrodes 602 and 604. Any suitable existing electrochromic cell structure may be used.

In embodiments, the electrically responsive material 600 comprises a suitable liquid crystal layer. In embodiments, the liquid crystal layer comprises a mixture of nematic liquid crystal, a dichroic dye, and a chiral dopant. The wt % of the dichroic dye, as well as the cell gap of the nematic liquid crystal may be selected to determine the maximum transmittance of the electrically responsive material 600. The maximum transmittance, which is a maximum average transmittance for the electrically responsive material 600 from 400 nm to 700 nm, may be approximated as

$${T}_{max} = {T}_{0} * {e}^{- wt \% * cellgap * C} \qquad ( 1 )$$

where Tₒ and C are constants determined through measurement. Such a state where the electrically responsive material comprises the maximum optical transmittance Tₘₐₓ may be referred to as a homeotropic state in which the liquid crystal and dichroic molecules are mostly vertically aligned perpendicular to the glass substrate 450. In embodiments, the wt % of the dichroic dye in the liquid crystal layer is greater than or equal to 1 wt % and less than or equal to 5 wt % and the cell gap for the nematic liquid crystal is greater than or equal to 3 μm and less than or equal to 20 μm. In such embodiments Tₘₐₓ for the electrically responsive material 600 may be greater than or equal to 40% and less than or equal to 90% (e.g., greater than or equal to 60% and less than or equal to 85%, greater than or equal to 60% and less than or equal to 80%, greater than or equal to 60% and less than or equal to 75%, greater than or equal to 60% and less than or equal to 70%).

In embodiments when the electrically responsive material 600 is a liquid crystal layer, the wt % of a chiral dopant can be selected (e.g., from any of the ranges provided herein) such that the liquid crystal material can be twisted from a first substrate 606 to a second substrate 608 at a twist angle that is greater than or equal to 180° and less than or equal to 1800°. Generally, the higher the twist angle, the lower the transmittance when the liquid crystal is in a planar twisted stated. That is, the liquid crystal layer can be configured such that, depending on the voltage applied between the first electrode 602 and the second electrode 604, the liquid crystals are twisted into a planar state, such that at least portions thereof extend approximately parallel to the second major surface 180 and block light transmittance to achieve a minimum average optical transmission Tₘᵢₙ for light from 400 nm to 700 nm. The higher the twist angle achieved via selection of the wt % of the chiral dopant, the lower value of Tₘᵢₙ that can be achieved. In embodiments, Tₘᵢₙ is less than or equal to 25% (e.g., less than or equal to 20% less than or equal to 20%, less than or equal to 19%, less than or equal to 18%, less than or equal to 17%, less than or equal to 16%, less than or equal to 15%, less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 6%, less than or equal to 5%).

In embodiments, depending on the particular cell gap and wt % of dichroic dye selected, the variable transmittance component 460 may be changed from the first configuration, where at least a portion of the electrically responsive material 600 comprises a minimum average optical transmittance to a second configuration, where at least a portion of the electrically responsive material 600 comprises a maximum optical average optical transmittance. In embodiments, when the variable transmittance component 460 is in the first configuration, the average optical transmittance in the image region 520 and the peripheral region 530 is less than or equal to 20% (e.g., less than or equal to 15%, less than or equal to 10) for light from 400 nm to 700 nm incident on the glass article at a 0° angle of incidence. In embodiments, when the variable transmittance component is in the second configuration, the average optical transmittance in at least the image region 520 is greater than or equal to 60% (e.g., greater than or equal to 65%, greater than or equal to 70%, greater than or equal to 75%, greater than or equal to 80%, greater than or equal to 85%, greater than or equal to 90%).

In embodiments, when the electrically responsive material 600 comprises a liquid crystal layer, the liquid crystal can be in any suitable alignment state when zero voltage is applied to the first electrode 602 and the second electrode 604. In embodiments, for example, the liquid crystal may be normally in the first configuration described herein in the absence of a potential difference. In such embodiments, the liquid crystal possesses a positive dielectric anisotropy and comprises a planar surface alignment (e.g., substantially parallel to the second major surface 480) in the absence of a potential difference, such that the transmittance comprises the Tₘᵢₙ value described herein as a default. In embodiments, the liquid crystal may normally be in the second configuration described herein, and possess relatively high optical transmission in the absence of a potential difference. In such embodiments, the liquid crystal possesses negative dielectric anisotropy and comprises a vertical alignment state (e.g., perpendicular to the second major surface 480) in the absence of a potential difference, such that the transmittance comprises the Tₘₐₓ value described herein as a default.

In embodiments, when the electrically responsive material 600 comprises a liquid crystal layer, the liquid crystal layer may also comprise a bistable surface alignment (e.g., where liquid crystals are both parallel and perpendicular to the second major surface 480) in the absence of a potential difference, such that the electrically responsive material 600 comprises a transmittance value between Tₘᵢₙ and Tₘₐₓ as a default without any voltage applied to the first and second electrodes 602 and 604. Examples of such a bistable liquid crystal layer is described in U.S. Pat. No. 8,384,872, entitled (“Bistable Nematic Liquid Crystal Device”), hereby incorporated by reference in its entirety. Formulating the electrically responsive material of a liquid crystal layer beneficially provides flexibility in terms of the default transmission state of the variable transmittance component 460 in the absence of any voltage supplied via the control system 495 (see FIG. 2).

Referring still to FIG. 3, in embodiments, the variable transmittance component 460 comprises the first substrate 606 and the second substrate 608 forming outer layers of the variable transmittance component 460. The first and second substrates 606 and 608 may protect the other components of the variable transmittance component 460 and serve as a base for deposition of other components of the variable transmission component 460 (e.g., electrode structures). The first substrate and the second substrate 606 and 608 may be constructed of any suitable material (e.g., a suitable glass material, a suitable polymeric material) having relatively high optical transmission and refractive index characteristics such that the glass article 400 possesses the optical transmittance and reflectance characteristics described herein.

In embodiments, the variable transmittance component 460 is constructed such that the glass article 400 exhibits a relatively low haze. For example, in embodiments, the glass article 400 exhibits a transmittance haze of less than or equal to 5% (e.g., less than or equal to 4%, less than or equal to 3%, less than or equal to 2.5%, less than or equal to 2.0%). Such haze performance may exclude certain materials from use as the electrically responsive material 600. For example, in embodiments, the electrically responsive material 600 does not include polymer dispersed liquid crystal materials, which tend to exhibit relatively high haze and degrade deadfronting performance. Electrically responsive materials incorporating any kind of scattering component (e.g., suspended particles without good index matching with host) may also exhibit relatively high haze and not be incorporated into the electrically responsive material 600.

In embodiments, the variable transmittance component 460 is further constructed to exhibit an average reflectance (e.g., measured at the interface between the glass substrate 450 and variable transmittance component 460) of less than or equal to 5.0% (e.g., less than or equal to 4.5%, less than or equal to 4.0%, less than or equal to 3.5%, less than or equal to 3.0%, less than or equal to 2.5%, less than or equal to 2.0%, less than or equal to 1.5%, less than or equal to 1.0%) for light from 400 nm to 700 nm that is normally incident on the glass article 400. Such a low reflectance beneficially allows most of the ambient light going through the variable transmittance component to be absorbed either in the low transmittance state of the variable transmittance component or at the opaque layer 500. Thus, very little ambient light is reflected back toward the viewer. Such a low reflectance beneficially aids in the glass article 400 having a uniform deadfronting appearance. Such reflectance requirements may further exclude certain materials from being used as the electrically responsive material 600. For example, in embodiments, the variable transmittance component 460 may exclude switchable micro-electro-mechanical (MEMS) mirrors or electrochromic components including reflectors in addition to an electrochromic material. Such components may exhibit unsuitably high reflectance for deadfronting applications.

Referring still to FIG. 3, in embodiments, the first and second electrodes 602 and 604 are constructed of a suitable transparent conductive material such as oxide (e.g., indium tin oxide or other suitable oxide), conductive polymer, or conductive nano particles. In such embodiments, any reflectance measured as originating from the variable transmittance component 460 (e.g., at the interface between the variable transmittance component 460 and the glass substrate 450, at any interface between different layers of the variable transmittance component 460) is primarily from the surfaces of the first and second substrates 606 and 608 or the first and second electrodes 602 and 604 and not from the electrically responsive material 600 or any reflective layer disposed adjacent thereto. In embodiments, less than 50% of a reflectance of the variable transmittance component 460 originates from interfaces of the electrically responsive material 600.

In embodiments, the glass article 400 exhibits a haze of less than or equal to 3.0% and a reflectance of less than or equal to 5.0% when illuminated with a D65 illuminant at a 0° illumination angle, irrespective of the configuration of the variable transmittance component 460. Such performance is achieved by selection of the electrically responsive material 600 and construction of the variable transmittance component 460 and beneficially aids in the glass article 400 having a desired appearance, while providing the deadfronting capabilities described herein.

With reference to FIGS. 2-3, the glass article 400, without the light source 540, may lack various components associated with existing display panels to provide the optical transmittance and reflectance performance attributes described herein. For example, the glass article 400 may lack polarization layers typically associated with LCD display structures. The glass article 400 may also lack a color filter layer or a transistor layer required to drive active matrix LCD. The lack of such components may aid the glass article 400 in having the relatively high average optical transmission when the variable transmittance component 460 is placed in the second configuration described herein.

In embodiments, the variable transmittance component 460 comprises two or more separately controllable regions, where the electrically responsive material 600 in each region can be independently placed in a desired optical transmission state. For example, FIG. 4 schematically depicts an embodiment of the variable transmittance component 460 wherein the first and second electrodes 602 and 604 described herein with respect to FIG. 3 are each segmented into different portions. The first electrode 602 is depicted to include a first portion 602a and a second portion 602b. The second electrode 604 is depicted to include a first portion 604a and a second portion 604b. In embodiments, the first portions 602a and 604a and the second portions 602b and 604b are independently addressable via the control system 495, such that different potential differences may be applied across different segments of the electrically responsive material 600. As a result, a first portion 600a of the electrically responsive material 600 may be placed in a different optical transmission state than a second portion 600b of the electrically responsive material 600 via application of different potential differences between the first portions 602a and 604a and the second portions 602b and 604b.

In embodiments, the electrically responsive material 600 is segmented into independently controllable portions (such as the first and second portions 600a and 600b depicted in FIG. 4) in a manner similar to pixels in a thin film transistor (TFT) LCD display. In embodiments, for example, the variable transmittance component comprises a TFT layer formed on the second substrate 608 adjacent the second electrode 604. The TFT layer may form a plurality of field effect transistors that may be used control the voltage applied to adjacent portions of the electrically responsive material 600 and thereby separately control the optical transmission state of such adjacent portions of the electrically responsive material 600. For example, a first field effect transistor may be disposed in the first portion 604a of the second electrode 604, and a second field effect transistor may be disposed in the second portion 604b of the second electrode 604. The first and second field effect transistors may be effectively used to separately control the optical transmission states of the first and second portions 600a and 600b of the electrically responsive material. In such embodiments, the variable transmittance component 460 may be similar in structure to a TFT LCD display, with the exceptions that the variable transmittance component 460 may lack polarization and color filter layers and comprise pixel sizes (with each “pixel” corresponding to a separately controllable portion of the electrically responsive material 600) that are much larger than typically in TFT LCD displays (e.g., the pixel sizes for the variable transmittance component 460 may be greater than or equal than 0.25 mm², greater than or equal than 0.5 mm² greater than or equal than 1.0 mm², greater than or equal to 2.0 mm², greater than or equal to 5.0 mm², or greater than or equal to 10 mm²).

In embodiments, the electrically responsive material 600 is segmented into independently controllable portions (such as the first and second portions 600a and 600b depicted in FIG. 4) in a manner similar to pixels in a passive matrix LCD display which does not have a TFT. In such embodiments, the variable transmittance component 460 has increased open aperture thus increased optical transmission, and is preferred. In embodiments, the electrically responsive material 600 is segmented into independently controllable portions (such as the first and second portions 600a and second portion 600b depicted in FIG. 4) without using either passive or active matrix, each portion being directly switchable. In such embodiments, the variable transmittance component 460 has increased optical transmission and lower manufacturing cost.

In embodiments, the first and second electrodes 602 and 604 may not overlap a portion of the electrically responsive material 600 such that a potential difference is never applied across that portion of the electrically responsive material and that portion always remains in the default optical transmission state.

In embodiments, the variable transmittance component 460 is constructed such that the separately controllable portions of the electrically responsive material 600 are situated in a desired arrangement within the glass article 400. For example, referring to FIGS. 2 and 4, the first portion 600a of the electrically responsive material 600 may be situated in the peripheral region 530 while the second portion 600b of the electrically responsive material 600 may be situated in the image region 520. Thetis, a boundary between the first portion 600a and the second portion 600b may coincide with the boundary between the image region 520 and the peripheral region 530. The optical transmission state of the electrically responsive material 600 may be spatially varied depending on the operation of the light source 540. For example, in embodiments, when the light source 540 is not emitting light, the first and second electrodes 602 and 604 may be operated such that both the first portion 600a and the second portion 600b of the electrically responsive material 600 are operated in the first optical transmission state (e.g., such that the electrically responsive material 600 in both the first portion 600a and the second portion 600b comprises the Tₘᵢₙ optical transmission value described herein) to conceal the light source 540 from view and provide the glass article 400 with a uniform appearance. When the light source 540 is emitting light, the first and second electrodes 602 and 604 may be operated such that only the second portion 600b of the electrically responsive material 600 changes from the first optical transmission state to the second optical transmission state, such that, in the image region 520, the electrically responsive material 600 (i.e., the second portion 600b) has the Tₘₐₓ value described herein. As a result, a contrast in optical transmission may occur between the image region 520 and the peripheral region 530 to allow viewers to view the light emitted by the light source 540. In embodiments, the first portion 600a, when situated in the peripheral region 530, is always operated in the first optical transmission state to occlude various components from view.

By segmenting control of the electrically responsive material 600 via the first and second electrodes 602 and 604, optical transmission contrasts between various regions of the glass article 400 may be established to facilitate deadfronting for various applications. For example, the first portion 600a may outline a peripheral shape of a backlit icon and always be operated in the low optical transmission state, and the second portion 600b may coincide with the lit area of the icon and change optical transmission states to facilitate viewability of the icon when lit and invisibility of the light source 540 when lights not emitted. In embodiments, the first and second portions 600a and 600b are further subdivided such that different portions of the electrically responsive material 600 within the image region 520 and peripheral region 530 can be separately controlled from one another to provide further flexibility.

It should be understood that the optical transmission state of any number of portions of the electrically responsive material 600 may be separately controlled from one another by varying the operation of the first and second electrodes 602 and 604 (e.g., by segmenting the first and second electrodes 602 and 604 into portions capable of receiving separate control signals from the control system 495 and/or by providing a suitable number and arrangement of transistors to control voltages provided to different portions of the electrically responsive material). In embodiments, the electrically responsive material 600 may include at least 2 (e.g., at least 3, at least 4, at least 5, at least 10, at least 100, or an even greater number) independently controllable portions. The control system 495 may control the optical transmission state of each of such independently controllable portions responsive to a variety of different inputs (e.g, from touch inputs received from a user, based on an operational state of the light source 540, based on feedback from one or more sensors). The optical transmittance in the visible spectrum for the variable transmittance component 460 may be spatially varied in any suitable pattern and/or time sequence to fit any deadfronting application.

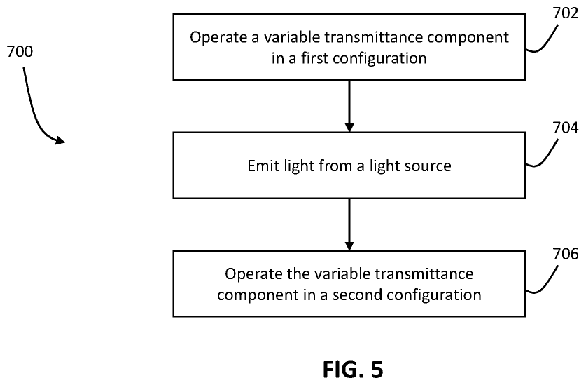

FIG. 5 depicts a flow diagram of a method 700 of controlling operation of a glass article, according to an example embodiment of the present disclosure. The method 700 may be used, for example, to control operation of the glass article 400 described herein in accordance with any of the embodiments described herein with respect to FIGS. 2-4. Reference will be made to various components described herein with respect to FIGS. 2-4 to aid in describing the method 700. In embodiments, various steps of the method 700 are performed via the control system 495. For example, the control system 495 may execute instructions stored thereon to provide control signals to various components of the display 230 in order to perform the method 700. It should be understood that the method 700 may be used to control components of systems other than the display 230 described herein. Moreover, actions may be performed by multiple control systems rather than a single control system.

At block 702, the control system 495 operates the variable transmittance component 460 in the first configuration described herein. In such a configuration, the electrically responsive material 600 may be operated in the Tₘᵢₙ state described herein. When the electrically responsive material 600 is operated in such a manner, glass article 400 may comprise an average optical transmittance that is less than or equal to 25% (e.g., less than or equal to 25%, less than or equal to 19%, less than or equal to 18%, less than or equal to 17%, less than or equal to 16%, less than or equal to 15%, less than or equal to 14%, less than or equal to 13%, less than or equal to 12%, less than or equal to 11%, less than or equal to 10%) over an entirety of a surface area thereof (e.g., in both the image region 520 and the peripheral region 530) such that the peripheral region 530 and image region 520 are color-matched and/or conceal the light source 540 from view. Such color matching may occur irrespective of whether the opaque layer 500 is included. Operating the variable transmittance component 460 in the first configuration may involve applying or not applying a voltage to various portions of the first electrode 602 and the second electrode 604, depending on the default optical transmission state of the electrically responsive material 600, as described herein.

At block 704, the control system 495 may cause the light source 540 to emit light. The light source 540 may be caused to emit light in response to a variety of different inputs (e.g., the vehicle being powered on, an input from a user by a touch panel (e.g., as a component of the light source 540 or elsewhere), an ambient light sensor, a proximity sensor, a movement sensor). The light source 540 may emit light intended for viewing by a viewer from the first major surface 470.

At block 706, the control system 495 may operate the variable transmittance component 460 in a second configuration. At least a portion of the electrically responsive material 600 may change from a first optical transmission state to a second optical transmission state, such that, within the portion of the glass article 400 where the electrically responsive material is changed to the second optical transmission state, the glass article 400 comprises an average optical transmission that is greater than or equal to 60% (e.g., greater than or equal to 65%, greater than or equal to 70%, greater than or equal to 75%, greater than or equal to 80%, greater than or equal to 85%, greater than or equal to 90%) for light from 400 nm to 700 nm that is normally incident on the glass article 400. As a result, the average optical transmission for such light in the peripheral region 530 may differ from the average transmission in the image region 520 by at least 40% (e.g., at least 50%, at least 60%, at least 70%, at least 80%). Such a transmission contrast may result from the opaque layer 500, the electrically responsive material 600 in the image region 520 being altered to the second optical transmission state (while the electrically responsive material 600 in the peripheral region 530, if present, remains in the first optical transmission state), or both. As a result, the optical transmission in the image region 520 may have a relatively high optical transmission to facilitate viewing the light from the light source 540 with relatively high contrast. When the light source 540 ceases to emit light, the method 700 may revert back to the block 702, so as to conceal the light source 540 from view and provide a deadfronted appearance.

### Glass Materials

Referring to FIG. 6, in embodiments the glass substrate 450 has a thickness t that is substantially constant over the width and length of the glass substrate 450 and is defined as a distance between the first major surface 470 and the second major surface 480. In various embodiments, T may refer to an average thickness or a maximum thickness of the glass substrate 450. In addition, the glass substrate 450 includes a width W defined as a first maximum dimension of one of the first or second major surfaces 470, 480 orthogonal to the thickness t, and a length L defined as a second maximum dimension of one of the first or second major surfaces 470, 480 orthogonal to both the thickness and the width. In other embodiments, W and L may be the average width and the average length of the glass substrate 450, respectively, and in other embodiments, W and L may be the maximum width and the maximum length of the glass substrate 450, respectively (e.g., for a glass substrate having a variable width or length).

In various embodiments, thickness tis 2 mm or less. In particular, the thickness t is from 0.30 mm to 2.0 mm. For example, thickness t may be in a range from about 0.30 mm to about 2.0 mm, from about 0.40 mm to about 2.0 mm, from about 0.50 mm to about 2.0 mm, from about 0.60 mm to about 2.0 mm, from about 0.70 mm to about 2.0 mm, from about 0.80 mm to about 2.0 mm, from about 0.90 mm to about 2.0 mm, from about 1.0 mm to about 2.0 mm, from about 1.1 mm to about 2.0 mm, from about 1.2 mm to about 2.0 mm, from about 1.3 mm to about 2.0 mm, from about 1.4 mm to about 2.0 mm, from about 1.5 mm to about 2.0 mm, from about 0.30 mm to about 1.9 mm, from about 0.30 mm to about 1.8 mm, from about 0.30 mm to about 1.7 mm, from about 0.30 mm to about 1.6 mm, from about 0.30 mm to about 1.5 mm, from about 0.30 mm to about 1.4 mm, from about 0.30 mm to about 1.4 mm, from about 0.30 mm to about 1.3 mm, from about 0.30 mm to about 1.2 mm, from about 0.30 mm to about 1.1 mm, from about 0.30 mm to about 1.0 mm, from about 0.30 mm to about 0.90 mm, from about 0.30 mm to about 0.80 mm, from about 0.30 mm to about 0.70 mm, from about 0.30 mm to about 0.60 mm, or from about 0.30 mm to about 0.40 mm. In other embodiments, the t falls within any one of the exact numerical ranges set forth in this paragraph.

In various embodiments, width W is in a range from 5 cm to 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. In other embodiments, W falls within any one of the exact numerical ranges set forth in this paragraph.

In various embodiments, length L is in a range from about 5 cm to about 2500 cm, from about 5 cm to about 2000 cm, from about 4 to about 1500 cm, from about 50 cm to about 1500 cm, from about 100 cm to about 1500 cm, from about 150 cm to about 1500 cm, from about 200 cm to about 1500 cm, from about 250 cm to about 1500 cm, from about 300 cm to about 1500 cm, from about 350 cm to about 1500 cm, from about 400 cm to about 1500 cm, from about 450 cm to about 1500 cm, from about 500 cm to about 1500 cm, from about 550 cm to about 1500 cm, from about 600 cm to about 1500 cm, from about 650 cm to about 1500 cm, from about 650 cm to about 1500 cm, from about 700 cm to about 1500 cm, from about 750 cm to about 1500 cm, from about 800 cm to about 1500 cm, from about 850 cm to about 1500 cm, from about 900 cm to about 1500 cm, from about 950 cm to about 1500 cm, from about 1000 cm to about 1500 cm, from about 1050 cm to about 1500 cm, from about 1100 cm to about 1500 cm, from about 1150 cm to about 1500 cm, from about 1200 cm to about 1500 cm, from about 1250 cm to about 1500 cm, from about 1300 cm to about 1500 cm, from about 1350 cm to about 1500 cm, from about 1400 cm to about 1500 cm, or from about 1450 cm to about 1500 cm. In other embodiments, L falls within any one of the exact numerical ranges set forth in this paragraph.

In embodiments, the glass substrate 450, may be formed from any suitable glass composition comprising soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may comprise SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition comprises Al₂O₃ in an amount greater than about 4 mol %, or greater than about 5 mol %. In one or more embodiments, the glass composition comprises Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from 9 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, glass layer(s) herein are described as an aluminosilicate glass article or comprising an aluminosilicate glass composition. In such embodiments, the glass composition or article formed therefrom comprises SiO₂ and Al₂O₃ and is not a soda lime silicate glass. In this regard, the glass composition or article formed therefrom comprises Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g, about 0.01 mol % or greater). In one or more embodiments, the glass composition comprises a non-zero amount of P₂O₅ up to and comprising 2 mol %, 1.5 mol %, 1 mol %, or 0.5 mol %. In one or more embodiments, the glass composition is substantially free of P₂O₅.

In one or more embodiments, the glass composition may comprise a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition comprises a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may comprise the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition comprises Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition comprises less than about 4 mol % K₂O, less than about 3 mol % K₂O, or less than about 1 mol % K₂O. In some instances, the glass composition may comprise K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O.

In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may comprise a total amount of RO (which is the total amount of alkaline earth metal oxide such as CaO, MgO, BaO, ZnO and SrO) in a range from about 0 mol % to about 2 mol %. In some embodiments, the glass composition comprises a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition comprises CaO in an amount less than about 1 mol %, less than about 0.8 mol %, or less than about 0.5 mol %. In one or more embodiments, the glass composition is substantially free of CaO. In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may comprise an oxide that imparts a color or tint to the glass articles. In some embodiments, the glass composition comprises an oxide that prevents discoloration of the glass article when the glass article is exposed to ultraviolet radiation. Examples of such oxides comprise, without limitation oxides of: Ti, V, Cr, Mn, Fe, Co, Ni, Cu, Ce, W, and Mo.

In one or more embodiments, the glass composition comprises Fe expressed as Fe₂O₃, wherein Fe is present in an amount up to (and comprising) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition comprises TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition comprises SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be comprised in the amounts otherwise disclosed herein.

### Strengthened Glass Properties

In one or more embodiments, the glass substrate 450 discussed herein may be formed from a strengthened glass sheet or article. In one or more embodiments, the glass articles used to form the layer(s) of the decorated glass structures discussed herein may be strengthened to comprise compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, the glass articles used to form the layer(s) of the decorated glass structures discussed herein may be strengthened mechanically by utilizing a mismatch of the coefficient of thermal expansion between portions of the glass to create a compressive stress region and a central region exhibiting a tensile stress. In some embodiments, the glass article may be strengthened thermally by heating the glass to a temperature above the glass transition point and then rapidly quenching.

In one or more embodiments, the glass articles used to form the layer(s) of the decorated glass structures discussed herein may be chemically strengthening by ion exchange. In the ion exchange process, ions at or near the surface of the glass article are replaced by—or exchanged with—larger ions having the same valence or oxidation state. In those embodiments in which the glass article comprises an alkali aluminosilicate glass, ions in the surface layer of the article and the larger ions are monovalent alkali metal cations, such as Lit, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass article generate a stress.

Ion exchange processes are typically carried out by immersing a glass article in a molten salt bath (or two or more molten salt baths) containing the larger ions to be exchanged with the smaller ions in the glass article. It should be noted that aqueous salt baths may also be utilized. In addition, the composition of the bath(s) may comprise more than one type of larger ion (e.g., Na+ and K+) or a single larger ion. It will be appreciated by those skilled in the art that parameters for the ion exchange process, comprising, but not limited to, bath composition and temperature, immersion time, the number of immersions of the glass article in a salt bath (or baths), use of multiple salt baths, additional steps such as annealing, washing and the like, are generally determined by the composition of the glass layer(s) of a decorated glass structure (comprising the structure of the article and any crystalline phases present) and the desired DOC and CS of the glass layer(s) of a decorated glass structure that results from strengthening.

Exemplary molten bath composition may comprise nitrates, sulfates, and chlorides of the larger alkali metal ion. Typical nitrates comprise KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on the glass thickness, bath temperature and glass (or monovalent ion) diffusivity. However, temperatures and immersion times different from those described above may also be used.

In one or more embodiments, the glass articles used to form the layer(s) of the decorated glass may be immersed in a molten salt bath of 100% NaNO₃, 100% KNO₃, or a combination of NaNO₃ and KNO₃ having a temperature from about 370° C. to about 480° C. In some embodiments, the glass layer(s) of a decorated glass may be immersed in a molten mixed salt bath comprising from about 5% to about 90% KNO₃ and from about 10% to about 95% NaNO₃. In one or more embodiments, the glass article may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass articles used to form the layer(s) of the decorated glass structures may be immersed in a molten, mixed salt bath comprising NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass layer(s) of a decorated glass structure. The spike may result in a greater surface CS value. This spike can be achieved by single bath or multiple baths, with the bath(s) having a single composition or mixed composition, due to the unique properties of the glass compositions used in the glass layer(s) of a decorated glass structure described herein.

In one or more embodiments, where more than one monovalent ion is exchanged into the glass articles used to form the layer(s) of the decorated glass structures, the different monovalent ions may exchange to different depths within the glass layer (and generate different magnitudes stresses within the glass article at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass article. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from GlasStress Ltd., located in Tallinn Estonia), depending on the strengthening method and conditions. When the glass article is chemically strengthenedby an ion exchange treatment, FSM or SCALP may be used depending on which ion is exchanged into the glass article. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM. Central tension or CT is the maximum tensile stress and is measured by SCALP.

In one or more embodiments, the glass articles used to form the layer(s) of the decorated glass structures maybe strengthened to exhibit a DOC that is described a fraction of the thickness t of the glass article (as described herein). For example, in one or more embodiments, the DOC may be equal to or greater than about 0.05t, equal to or greater than about 0.1t, equal to or greater than about 0.11 t, equal to or greater than about 0.12t, equal to or greater than about 0.13t, equal to or greater than about 0.14t, equal to or greater than about 0.15t, equal to or greater than about 0.16t, equal to or greater than about 0.17t, equal to or greater than about 0.18t, equal to or greater than about 0.19t, equal to or greater than about 0.2t, equal to or greater than about 0.21t. In some embodiments, The DOC may be in a range from about 0.08t to about 0.25t, from about 0.09t to about 0.25t, from about 0.18t to about 0.25t, from about 0.11t to about 0.25t, from about 0.12t to about 0.25t, from about 0.13t to about 0.25t, from about 0.14t to about 0.25t, from about 0.15t to about 0.25t, from about 0.08t to about 0.24t, from about 0.08t to about 0.23t, from about 0.08t to about 0.22t, from about 0.08t to about 0.21t, from about 0.08t to about 0.2t, from about 0.08t to about 0.19t, from about 0.08t to about 0.18t, from about 0.08t to about 0.17t, from about 0.08t to about 0.16t, or from about 0.08t to about 0.15t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the glass articles used to form the layer(s) of the decorated glass structures may have a CS (which may be found at the surface or a depth within the glass article) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the glass articles used to form the layer(s) of the decorated glass structures may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to comprise one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

1. A glass article comprising:
a glass substrate comprising a first major surface and a second major surface opposite the first major surface; and
a variable transmittance component disposed on the second major surface of the glass substrate, the variable transmittance component comprising an electrically responsive material configured to switch between a first transmission state and a second transmission state in response to a change in voltage applied to the variable transmittance component, wherein:
the variable transmittance component is electrically adjustable between a first configuration, in which at least a portion of the electrically responsive material is in the first transmission state such that a first average transmittance of a region of the glass article including the portion is less than or equal to 25% and a second configuration, in which the portion of the electrically responsive material is in the second transmission state and the region comprises a second average transmittance that is greater than or equal to 40%,
the first average transmittance and the second average transmittance are measured over a wavelength range of 400 nm to 700 nm, and
in both the first configuration and the second configuration, the glass article exhibits a transmission haze that is less than or equal to 5%.

2. The glass article according to claim 1, wherein, in both the first configuration and the second configuration, the glass article exhibits an average reflectance less than or equal to 5% for light from 400 nm to 700 nm that is normally incident on the first major surface.

3. The glass article according to claim 1, wherein:
the variable transmittance component defines a boundary between a first region of the glass article and a second region of the glass article, the first region at least partially surrounding the second region,
the portion that changes from the first transmission state to the second transmission state when the variable transmittance component is adjusted between the first configuration and the second configuration is disposed in the second region,
when the variable transmittance component is in the first configuration, a difference between average transmittances of the first region and the second region is less than or equal to 10%, and
when the variable transmittance component is in the second configuration, the difference between the average transmittances is greater than or equal to 40%.

4. The glass article according to claim 1, further comprising a light source disposed adjacent the variable transmittance component, wherein the light source is configured to emit light through the portion that changes from the first transmission state to the second transmission state when the variable transmittance component is adjusted between the first configuration and the second configuration, wherein, when the light source is emitting light and the variable transmittance component is in the second configuration, the glass article exhibits a sparkle of 2% or less when viewed from the first major surface.

5. (canceled)

6. (canceled)

7. (canceled)

8. The glass article according to claim 1, wherein:
irrespective of whether the variable transmittance component is in the first configuration or the second configuration, a peripheral region of the glass article comprises an average transmittance that is less than or equal to 20% for light from 400 nm to 700 nm,
when the variable transmittance component is in the first configuration, the peripheral region comprises a first a* value and a first b* value and the portion that changes from the first transmission state to the second transmission state when the variable transmittance component is adjusted between the first configuration and the second configuration comprises a second a* value and a second b* value, when the glass article is illuminated using a D65 illuminant at an illumination angle of 0°,
the first a* value and the second a value differ from one another by less than or equal to 5.0, and
the first b* value and the second b* value differ from one another by less than or equal to 5.0.

9. The glass article according to claim 8, wherein ΔE=√{(a*₁−a*₂)²+(b*₁−b*₂)²}≤3, where a*₁ is the first a* value, a*₂ is the second a* value, b*₁ is the first b* value, and b*₂ is the second b* value.

10. The glass article according to claim 1, wherein the variable transmittance component comprises a first electrode, the electrically responsive material, and a second electrode, wherein the electrically responsive material is disposed between the first electrode and the second electrode and the first electrode is disposed proximate to the glass substrate.

11. The glass article according to claim 10, wherein the electrically responsive material comprises an uncovered portion that is not overlapped by the first and second electrodes such that the uncovered portion is permanently in the second transmission state.

12. The glass article according to claim 10, wherein the electrically responsive material is segmented into a plurality of independently controllable portions, wherein the first electrode and the second electrode are segmented into a plurality of electrode portions overlapping the plurality of independently controllable portions of the electrically responsive material.

13. The glass article according to claim 10, wherein the electrically responsive material comprises an electrophoretic layer or an electrochromic layer.

14. The glass article according to claim 10, wherein the electrically responsive material comprises a liquid crystal layer.

15. The glass article according to claim 14, wherein:
the liquid crystal layer comprises a mixture of nematic liquid crystal, a dichroic dye, and a chiral dopant,
the dichroic dye comprises greater than or equal to 1 wt % and less than or equal to 5 wt % of the mixture, and
a cell gap of the nematic liquid crystal is greater than or equal to 3 μm and less than or equal to 20 μm.

16. An apparatus comprising:
a glass substrate comprising a first major surface and a second major surface opposite the first major surface;
a variable transmittance component disposed on the second major surface of the glass substrate, the variable transmittance component comprising an electrically responsive material configured to switch between a first transmission state and a second transmission state in response to a change in voltage applied to the variable transmittance component; and
a light source disposed on a surface of the variable transmittance component, the light source comprising a light transmission area, wherein:
the electrically responsive material covers the light transmission area of the light source such that light emitted by the light source propagates through the electrically responsive material prior to reaching the glass substrate,
the variable transmittance component is electrically adjustable between a first configuration, in which at least a portion of the electrically responsive material is in the first transmission state such that a first average transmittance of a region of the glass article including the portion is less than or equal to 20% and a second configuration, in which the portion of the electrically responsive material is in the second transmission state and the region comprises a second average transmittance that is greater than or equal to 60%,
the first average transmittance and the second average transmittance are measured over a wavelength range of 400 nm to 700 nm, and
in both the first configuration and the second configuration, the glass article exhibits at least one of a transmission haze that is less than or equal to 5% or an average an average reflectance less than or equal to 5% for light from 400 nm to 700 nm that is normally incident on the first major surface.

17. (canceled)

18. (canceled)

19. (canceled)

20. The apparatus according to claim 16, wherein:
irrespective of whether the variable transmittance component is in the first configuration or the second configuration, a peripheral region of the glass article comprises an average transmittance that is less than or equal to 20% for light from 400 nm to 700 nm,
when the variable transmittance component is in the first configuration, the peripheral region comprises a first a* value and a first b* value and the region containing the portion that changes from the first transmission state to the second transmission state when the variable transmittance component is adjusted between the first configuration and the second configuration comprises a second a* value and a second b* value, when the glass article is illuminated using a D65 illuminant at an illumination angle of 0°,
the first a* value and the second a value differ from one another by less than or equal to 5.0, and
the first b* value and the second b* value differ from one another by less than or equal to 5.0.

21. The glass article according to claim 20, wherein ΔE=√{(a*₁−a*₂)²+(b*₁−b*₂)²}≤3, where a*₁ is the first a* value, a*₂ is the second as value, b*₁ is the first b* value, and b*₂ is the second b* value, wherein, when the light source is emitting light and the variable transmittance component is in the second configuration, the glass article exhibits a sparkle of 2% or less when viewed from the first major surface.

22. (canceled)

23. The apparatus according to claim 16, wherein the variable transmittance component comprises a first electrode, the electrically responsive material, and a second electrode, wherein the electrically responsive material is disposed between the first electrode and the second electrode and the first electrode is disposed proximate to the glass substrate.

24. The apparatus according to claim 23, wherein the electrically responsive material comprises an uncovered portion that is not overlapped by the first and second electrodes such that the uncovered portion is permanently in the second transmission state.

25. The apparatus according to claim 24, wherein the electrically responsive material is segmented into a plurality of independently controllable portions, wherein the first electrode and the second electrode are segmented into a plurality of electrode portions overlapping the plurality of independently controllable portions of the electrically responsive material.

26. The apparatus according to claim 23, wherein the electrically responsive material comprises an electrophoretic layer or an electrochromic layer.

27. The apparatus according to claim 23, wherein:
the electrically responsive material comprises a liquid crystal layer,
the liquid crystal layer comprises a mixture of nematic liquid crystal, a dichroic dye, and a chiral dopant,
the dichroic dye comprises greater than or equal to 1 wt % and less than or equal to 5 wt % of the mixture, and
a cell gap of the nematic liquid crystal is greater than or equal to 3 μm and less than or equal to 20 μm.

28. (canceled)

29. (canceled)

30. (canceled)
